(19) United States
(12) Patent Application Publication
(10) Pub. No.: US 2017/0180087 A1
(43) Pub. Date: Jun. 22, 2017

(54) APPARATUS AND METHOD FOR PROCESSING SIGNAL IN MULTIPLE ACCESS MOBILE COMMUNICATION SYSTEM BASED ON MULTIPLE BEAMS, AND MULTIPLE ACCESS MOBILE COMMUNICATION SYSTEM BASED ON MULTIPLE BEAMS

(71) Applicant: ELECTRONICS AND TELECOMMUNICATIONS RESEARCH INSTITUTE, Daejeon (KR)

(72) Inventors: Young Jo BANG, Daejeon (KR); IL GYU KIM, Okcheon-gun (KR); Jun Woo KIM, Daejeon (KR)

(73) Assignee: ELECTRONICS AND TELECOMMUNICATIONS RESEARCH INSTITUTE, Daejeon (KR)

(21) Appl. No.: 15/241,646

(22) Filed: Aug. 19, 2016

(30) Foreign Application Priority Data
Dec. 18, 2015 (KR) 10-2015-0181434
Jun. 29, 2016 (KR) 10-2016-0081338

(51) Int. Cl. H04L 5/00; H04L 27/26; H04W 72/04

(52) U.S. Cl. CPC H04L 5/001; H04W 72/0406; H04L 27/2608

(57) ABSTRACT

Provided are an apparatus and a method for processing signal in a multiple access mobile communication system based on multiple beams, and a multiple access mobile communication system based on multiple beams. The apparatus includes: a modulating unit modulating a common control signal and a traffic data signal to be transmitted to a plurality of respective communication terminals; a mapping unit mapping the common control signal and the traffic data signal modulated by the modulating unit to subcarriers, respectively; a phase shifting unit phase-shifting the common control signal mapped to the subcarrier as long as a delay time designated to correspond to the plurality of communication terminals; and a Fourier transforming unit generating a transmission signal corresponding to each communication terminal by Fourier-transforming the respective subcarriers to which the common control signal and the traffic data signal phase-shifted as long as the designated delay time are mapped.

### CROSS-REFERENCE TO RELATED APPLICATIONS

This application claims priority to and the benefit of Korean Patent Application No. 10-2015-0181434 filed in the Korean Intellectual Property Office on Dec. 18, 2015 and Korean Patent Application No. 10-2016-0081338 filed in the Korean Intellectual Property Office on Jun. 29, 2016, the entire contents of which are incorporated herein by reference.

### TECHNICAL FIELD

The present invention relates to an apparatus and a method for processing a signal in a multiple access mobile communication system based on multiple beams, and a multiple access mobile communication system based on multiple beams.

### BACKGROUND ART

In a multiple access mobile communication system based on multiple beams, a base station and multiple terminals can transmit/receive signals while sharing the same frequency band and the same time slot based on multiple-beam technology. In this case, multiple terminals that belong to the same beam communicate with the base station by being allocated with orthogonal components split in a time or frequency domain.

The base station needs to simultaneously transmit control signals such as paging information, system information, resource allocation information, and the like which all terminals commonly require to all beams so that the base station and the terminal perform the communication as described above.

As described above, when a common control signal is simultaneously transmitted to several beams, a shadow zone may occur due to a frequency smooth fading phenomenon under a pencil beam communication or millimeter wave communication environment in which multiple propagation paths are less. Accordingly, a possibility that an intact common control signal will not be received increases.

### SUMMARY OF THE INVENTION

The present invention has been made in an effort to provide an apparatus and a method for processing a signal in a multiple access mobile communication system based on multiple beams, and a multiple access mobile communication system which allow a wireless channel of each communication terminal to have a frequency selective fading characteristic by transmitting a common control signal to each communication terminal by varying a delay time for each beam to detect data with reliability in the case of transmitting the common control signal to the multiple beams while a base station and multiple communication terminals access each other in a multiple access mobile communication system based on the multiple beams.

The technical objects of the present invention are not limited to the aforementioned technical objects, and other technical objects, which are not mentioned above, will be apparently appreciated to a person having ordinary skill in the art from the following description.

An exemplary embodiment of the present invention provides an apparatus for processing a signal in a multiple access mobile communication system based on multiple beams, including: a modulating unit modulating a common control signal and a traffic data signal to be transmitted to a plurality of respective communication terminals accessing a base station; a mapping unit mapping the common control signal and the traffic data signal modulated by the modulating unit to subcarriers, respectively; a phase shifting unit phase-shifting the common control signal mapped to the subcarrier as long as a delay time designated to correspond to the plurality of communication terminals; and a Fourier transforming unit generating a transmission signal corresponding to each communication terminal by Fourier-transforming the respective subcarriers to which the common control signal and the traffic data signal phase-shifted as long as the designated delay time are mapped.

The transmission signal corresponding to each communication terminal may be transmitted through an antenna of the base station in the form of a beam, and the common control signal corresponding to each communication terminal may be each transmitted to the corresponding communication terminal through the beam with different delay time.

The modulating unit may modulate the common control signal and the traffic data signal to be transmitted to each of the plurality of communication terminals by an Orthogonal Frequency Division Multiplexing (OFDM) scheme.

The mapping unit may map the common control signal and the traffic data corresponding to each of the plurality of communication terminals to different subcarriers.

The Fourier transforming unit may perform inverse fast Fourier transform (IFFT) of the subcarrier signal to which the common control signal and the traffic data signal phase-shifted as long as the designated delay time are mapped.

The phase shifting unit may calculate a phase shift value for the corresponding subcarrier in proportion to the number of time-domain samples of the delay time designated for the communication terminal which is to transmit the common control signal and in inverse proportion to the size of the IFFT of the Fourier transforming unit.

The apparatus may further include: an analog converting unit digital to analog converting the transmission signal corresponding to each communication terminal and outputting the analog signal; and a frequency up converting unit up-converting a frequency of each transmission signal converted into the analog signal and outputting the frequency up converted signal through the antenna of the base station.

Another exemplary embodiment of the present invention provides a method for processing a signal in a multiple access mobile communication system based on multiple beams including: modulating a common control signal and a traffic data signal to be transmitted to a plurality of respective communication terminals accessing a base station; mapping the modulated common control signal and traffic data signal to subcarriers, respectively; phase-shifting the common control signal mapped to the subcarrier as long as a delay time designated to correspond to the plurality of communication terminals, respectively; and generating a transmission signal corresponding to each communication terminal by Fourier-transforming the subcarriers to which the common control signal and the traffic data signal phase-shifted as long as the designated delay time are mapped.

The method may further include transmitting the transmission signal corresponding to each communication terminal through an antenna of the base station in the form of a beam.

The common control signal corresponding to each communication terminal may be each transmitted to the corresponding communication terminal through the beam with different delay time.

In the modulating, the common control signal and the traffic data signal to be transmitted to each of the plurality of communication terminals may be modulated by an Orthogonal Frequency Division Multiplexing (OFDM) scheme.

In the mapping, the common control signal and the traffic data corresponding to each of the plurality of communication terminals may be mapped to different subcarriers.

The generating of the transmission signal corresponding to each communication terminal may include performing inverse fast Fourier transform (IFFT) of the subcarrier signal to which the common control signal and the traffic data signal phase-shifted as long as the designated delay time are mapped.

The phase shifting may include calculating a phase shift value for the corresponding subcarrier in proportion to the number of time-domain samples of the delay time designated for the communication terminal which is to transmit the common control signal and in inverse proportion to the size of the IFFT of the Fourier transforming unit.

The method may further include: digital to analog converting the transmission signal corresponding to each communication terminal and outputting the analog signal; and up-converting a frequency of each transmission signal converted into the analog signal and outputting the frequency up converted signal through the antenna of the base station.

Yet another exemplary embodiment of the present invention provides a multiple access mobile communication system based on multiple beams, including: a plurality of communication terminals supporting a communication service of a mobile communication system; and a base station having a signal processing apparatus modulating a common control signal and a traffic data signal to be transmitted to a plurality of respective communication terminals and mapping the modulated signals to different subcarriers while multiple accessing the plurality of communication terminals, phase-shifting the common control signal mapped to the subcarrier as long as a delay time designated to correspond to the plurality of communication terminals, and transmitting each beam including the phase-shifted common control signal and traffic data signal to the corresponding communication terminal inside or outside.

According to exemplary embodiments of the present invention, a wireless channel of each terminal is allowed to have a frequency selective fading characteristic by transmitting a common control signal to each communication terminal by varying a delay time for each beam to detect data with reliability in the case of transmitting the common control signal to the multiple beams while a base station and multiple communication terminals access each other in a multiple access mobile communication system based on the multiple beams.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a configuration of a multiple access mobile communication system based on multiple beams according to the present invention.

FIG. 2 is a diagram illustrating a configuration of an apparatus for processing a signal in a multiple access mobile communication system based on multiple beams according to the present invention.

FIG. 3 is a diagram illustrating an exemplary embodiment referred to for describing a signal processing operation of a signal processing apparatus according to the present invention.

FIG. 4 is a diagram illustrating an operational flow for a method for processing a signal according to the present invention.

FIG. 5 is a diagram illustrating a configuration of a computing system to which the apparatus is applied according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

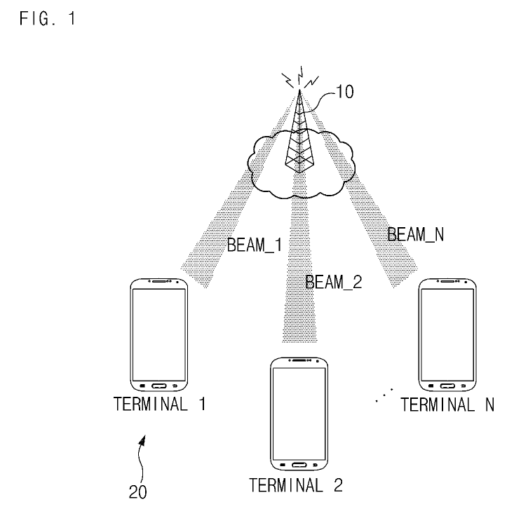

FIG. 1 is a diagram illustrating a configuration of a mobile communication system according to the present invention.

Referring to FIG. 1, the mobile communication system according to the present invention as a multiple access mobile communication system based on multiple beams may include a base station 10 and a plurality of communication terminals 20 which multiple accesses the base station 10.

Herein, for easy description, it is assumed that one terminal is allocated to each beam and N terminals communicate by an OFDMA scheme in the same time and frequency in N beams, respectively, but multiple terminals may be present in each beam or one terminal may not be present in each beam. Therefore, the beam and the terminal will be described as the same meaning in the following description.

Herein, as the communication terminal 20, either mobile communication terminal which may beam-communicate with the base station 10 may be applied.

As one example, a smart phone, a tablet personal computer (PC), a personal digital assistant (PDA), a portable multimedia player (PMP), an MP3 player, a wearable device, or a smart watch may correspond to the communication terminal 20.

The base station 10 multiple-accesses the plurality of communication terminals 20 to transmit a plurality of beams to the respective communication terminals 20, respectively. In this case, the base station 10 may include a signal processing apparatus that processes the beams transmitted to the plurality of communication terminals 20.

When the signal processing apparatus transmits traffic data to each communication terminal 20 which accesses the base station 10, the signal processing apparatus transmits the traffic data by using respective different beams and in this case, the signal processing apparatus may load the common control signal on the beam transmitted to each communication terminal 20 and transmit the common control signal. The common control signal may include control signals associated with paging information, system information, and resource allocation information which each communication terminal 20 accessing the base station 10 commonly requires to receive data.

Herein, the signal processing apparatus transmits the beam by varying a delay time for each common control signal transmitted to each communication terminal 20.

In this case, even though the signal processing apparatus simultaneously loads the common control signal on the multiple beams and transmits the common control signal, a wireless channel of each communication terminal 20 has a frequency selective fading characteristic, and as a result, the communication terminal 20 may detect the common control signal with reliability.

The signal processing apparatus may be implemented in the base station 10 and be implemented outside the base station 10 to be connected with the base station 10 through separate connection means.

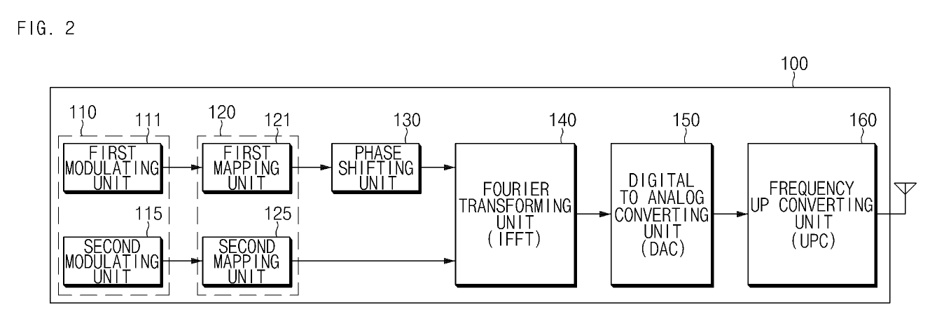

Therefore, detailed constitutions and operations of the signal processing apparatus of the base station 10 will be described in more detail with reference to FIG. 2.

FIG. 2 is a diagram illustrating a configuration of a signal processing apparatus of a base station according to the present invention.

Referring to FIG. 2, the signal processing apparatus 100 may include a modulating unit 110, a mapping unit 120, a phase shifting unit 130, a Fourier transforming unit 140, a digital to analog converting unit (DAC) 150, and a frequency up converting unit (UPC) 160.

The modulating unit 110 serves to modulate the common control signal and a traffic data signal to be transmitted to any one communication terminal among the plurality of communication terminals accessing the base station and output the modulated signals to the mapping unit 120. In this case, the modulating unit 110 may modulate the common control signal and the traffic data signal by an orthogonal frequency division multiplexing (OFDM) scheme.

Herein, the modulating unit 110 may include a first modulating unit 111 and a second modulating unit 115.

First, the first modulating unit 111 modulates the common control signal to be transmitted to any one communication terminal accessing the base station, for example, an n-th communication terminal by the orthogonal frequency division multiplexing (OFDM) scheme and outputs the modulated common control signal to the first mapping unit 121. Meanwhile, the second modulating unit 115 modulates the traffic data signal to be transmitted to the n-th communication terminal by the orthogonal frequency division multiplexing (OFDM) scheme and outputs the modulated traffic data signal to the second mapping unit 125.

The mapping unit 120 serves to map the common control signal and the traffic data signal modulated by the modulating unit 110 to a subcarrier and output the signals. Herein, the mapping unit 120 may include a first mapping unit 121 and a second mapping unit 125.

First, the first mapping unit 121 may map the common control signal modulated by the first modulating unit 111 by the OFDM scheme to an n-th subcarrier and output the common control signal to the phase shifting unit 130. In this case, the modulated common control signal is mapped to different subcarriers to correspond to each communication terminal.

Herein, the phase shifting unit 130 may shift a phase as long as a delay time tₙ designated to correspond to an n-th communication terminal with respect to the common control signal mapped to the n-th subcarrier by the first mapping unit 121. In this case, the delay time is designated differently for each communication terminal.

A phase shift value applied to the phase shifting unit 130 for each communication terminal may be shown in [Equation 1] given below.

$${φ}_{k} = \frac{2 π k τ}{M} \qquad [ Equation 1 ]$$

In [Equation 1], φk represents the phase shift value for a k-th subcarrier, τ represents the number of time domain samples of a delay time tₖ, and M represents inverse fast Fourier transform (IFFT) size.
The phase shifting unit 130 phase-shifts the common control signal as large as φn, the phase shift value for the delay time tₙ designated with respect to the n-th communication terminal based on [Equation 1] and outputs the common control signal phase-shifted while being mapped to the n-th subcarrier to the Fourier transforming unit 140.

Meanwhile, the second mapping unit 125 maps the traffic data signal mapped to the n-th subcarrier to the n-th subcarrier by the second modulating unit 115 and outputs the traffic data signal to the Fourier transforming unit 140.

Herein, the first mapping unit 121 and the second mapping unit 125 may map the modulated common control signal and traffic data to the same subcarrier, respectively. Further, the mapping unit 120 may map the modulated common control signal and traffic data to different subcarriers to correspond to the respective communication terminals.

The Fourier transforming unit 140 Fourier-transforms the subcarrier signal to which the common control signal and the traffic data phase-shifted as long as the designated delay time are mapped and outputs the corresponding subcarrier signal to the DAC. Herein, the Fourier transforming unit 140 may perform inverse fast Fourier transform (IFFT) with respect to the input subcarrier signal.

The signal IFFT-processed by the Fourier transforming unit 140 is digital to analog converted through the analog transforming unit 150 and frequency-up adjusted by the frequency up converting unit 160. Accordingly, the signal frequency up-adjusted by the frequency up converting unit 160 is transmitted to the n-th communication terminal in an n-th beam form an antenna.

As such, since the beam transmitted to each communication terminal includes the common control signal phase-shifted as long as different delay time, it is possible to detect the common control signal with reliability in each communication terminal.

Although not illustrated in FIG. 2, the signal processing apparatus of the base station may further include a storage unit (not illustrated) storing data and a program required for operating the signal processing apparatus 100.

The storage unit may store a set value for operating the signal processing apparatus 100. As one example, the storage unit may store a delay time designated to correspond to each communication terminal and store the phase shift value depending on the delay time or an algorithm for calculating the phase shift value.

The storage unit may store a condition value, data, and an algorithm required for performing each operation in the modulating unit 110, the mapping unit 120, the Fourier transforming unit 140, the digital to analog converting unit 150, and the frequency up converting unit 160.

Herein, the storage unit may include at least one storage medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM).

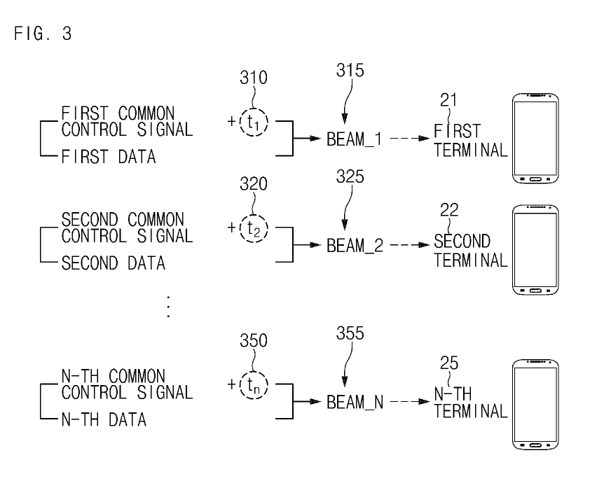

FIG. 3 is a diagram illustrating an exemplary embodiment referred to for describing a signal processing operation of a signal processing apparatus according to the present invention. In detail, FIG. 3 illustrates an exemplary embodiment referred for describing a phase shift operation for the common control signal to be transmitted to each communication terminal.

Referring to FIG. 3, the signal processing apparatus of the base station differently designates the delay time for the common control signal for each communication terminal accessing the base station.

As one example, a delay time for a first common control signal to be transmitted to a first terminal 21 may be designated as t₁ 310 and a delay time for a second common control signal to be transmitted to a second terminal 22 may be designated as t₂ 320. In such a manner, a delay time for an N-th common control signal to be transmitted to an N-th terminal 25 may be designated as t_{N} 350.

The base station phase-shifts the common control signal for the first terminal 21, the second terminal 22, . . . , the N-th terminal 25 as long as the delay time t₁ 310, t₂ 320, . . . , t_{N} 350, respectively and transmits the phase-shifted common control signal and data signal to the first terminal 21, the second terminal 22, . . . , the N-th terminal 25, respectively in the forms of beam_1 315, beam_2 325, . . . , beam_N 355.

In this case, since the common control signal of beam_1 315, beam_2 325, . . . , beam_N 355 is transmitted by varying the delay time, wireless channels of the first terminal 21, the second terminal 22, . . . , the N-th terminal 25 have the frequency selective fading characteristic. Accordingly, the first terminal 21, the second terminal 22, . . . , the N-th terminal 25 may receive the common control signal with reliability through beam_1 315, beam_2 325, . . . , beam_N 355, respectively.

An operational flow of the apparatus according to the present invention, which is configured as above will be described below in more detail.

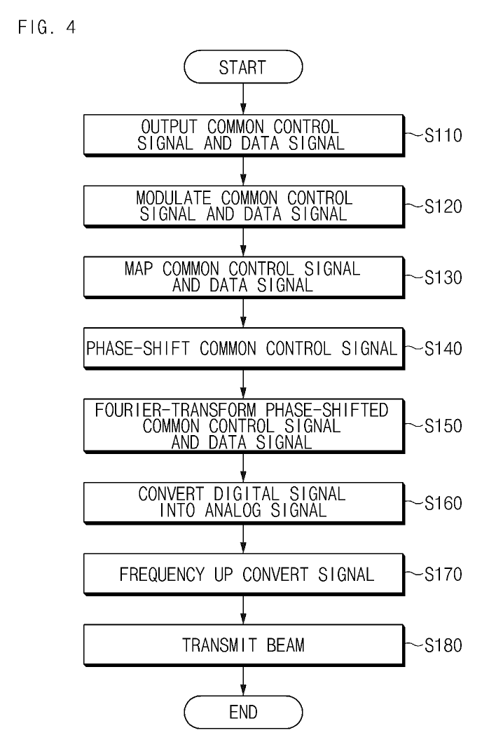

FIG. 4 is a diagram illustrating an operational flow for a method for processing a signal of a base station according to the present invention.

When the plurality of communication terminals multiple-accesses the base station, the signal processing apparatus transmits the common control signal and the traffic data signal to each communication terminal. In the exemplary embodiment of FIG. 4, a procedure of transmitting the beam to the n-th communication terminal among the plurality of communication terminals which multiple-accesses the base station will be described.

Referring to FIG. 4, the signal processing apparatus outputs the common control signal and the traffic data signal to be transmitted the n-th communication terminal among the plurality of communication terminals accessing the base station (S110).

In this case, the signal processing apparatus signal-modulates each of the common control signal and the traffic data signal output during process ‘S110’ by the OFDM scheme (S120) and maps the common control signal and the traffic data signal signal-modulated during process ‘S120’ to the subcarriers, respectively (S130).

The signal processing apparatus performs the phase shift of the common control signal mapped to the subcarrier as long as a delay time designated with respect to the n-th communication terminal (S140).

Thereafter, the signal processing apparatus performs Fourier transform, in detail, inverse fast Fourier transform (IFFT) of the subcarrier to which the common control signal and the traffic data signal phase-shifted as long as the designated delay time are mapped (S150).

The signal inverse fast Fourier transformed during process ‘S150’ is converted into the analog signal by the digital to analog converting unit (S160) and the converted analog signal is frequency up converted (S170).

The signal processing apparatus transmits a beam corresponding to the frequency up converted signal during process ‘S170’ to the n-th communication terminal (S180).

In the exemplary embodiment of FIG. 4, a procedure of transmitting the beam including the common control signal and the traffic data signal to the n-th communication terminal has been described, but the beam may be transmitted to each of different communication terminals accessing the base station by forming the beams through processes ‘S110’ to ‘S180’, respectively. Of course, the delay time designated during process ‘S140’ varies for each communication terminal accessing the base station, and as a result, the phase shift value also varies.

Accordingly, the common control signal transferred through each beam is transmitted by varying the delay time.

The signal processing apparatus according to the exemplary embodiment, which operates as described above may be implemented as an independent hardware device form and at least one processor may be driven while being included in another hardware device such as a microprocessor or a universal computer system.

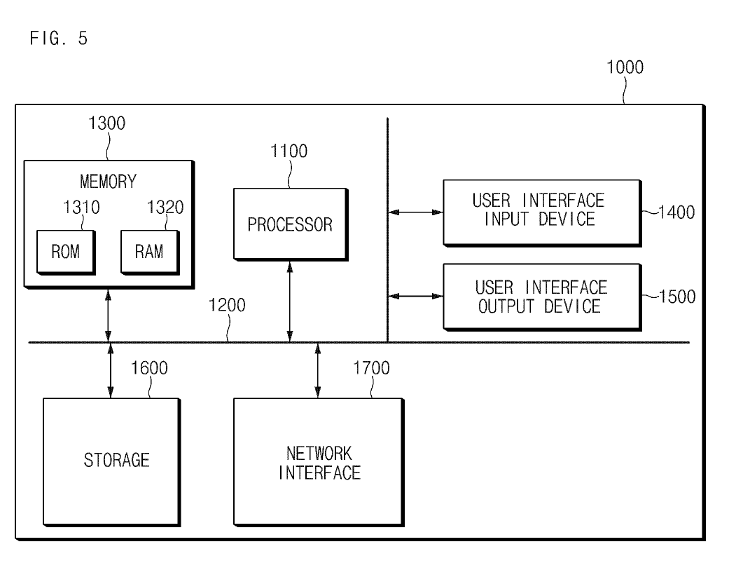

FIG. 5 is a diagram illustrating a computing system to which the apparatus according to the present invention is applied.

Referring to FIG. 5, the computing system 1000 may include at least one processor 1100, a memory 1300, a user interface input device 1400, a user interface output device 1500, a storage 1600, and a network interface 1700 connected through a bus 1200.

The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in the user terminal. As yet another method, the processor and the storage medium may reside in the user terminal as individual components.

The above description just illustrates the technical spirit of the present invention and various changes and modifications can be made by those skilled in the art to which the present invention pertains without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range thereto is intended to be embraced by the scope of the present invention.

What is claimed is:

1. An apparatus for processing a signal in a multiple access mobile communication system based on multiple beams, the apparatus comprising:
a modulating unit modulating a common control signal and a traffic data signal to be transmitted to a plurality of respective communication terminals accessing a base station;
a mapping unit mapping the common control signal and the traffic data signal modulated by the modulating unit to subcarriers, respectively;
a phase shifting unit phase-shifting the common control signal mapped to the subcarrier as long as a delay time designated to correspond to the plurality of communication terminals; and
a Fourier transforming unit generating a transmission signal corresponding to each communication terminal by Fourier-transforming the respective subcarriers to which the common control signal and the traffic data signal phase-shifted as long as the designated delay time are mapped.

2. The apparatus of claim 1, wherein the transmission signal corresponding to each communication terminal is transmitted through an antenna of the base station in the form of a beam, and
the common control signal corresponding to each communication terminal is each transmitted to the corresponding communication terminal through the beam with different delay time.

3. The apparatus of claim 1, wherein the Fourier transforming unit performs inverse fast Fourier transform (IFFT) of the subcarrier signal to which the common control signal and the traffic data signal phase-shifted as long as the designated delay time are mapped.

4. The apparatus of claim 3, wherein the phase shifting unit calculates a phase shift value for the corresponding subcarrier in proportion to the number of time-domain samples of the delay time designated for the communication terminal which is to transmit the common control signal and in inverse proportion to the size of the IFFT of the Fourier transforming unit.

5. The apparatus of claim 1, wherein the modulating unit modulates the common control signal and the traffic data signal to be transmitted to each of the plurality of communication terminals by an Orthogonal Frequency Division Multiplexing (OFDM) scheme.

6. The apparatus of claim 1, wherein the mapping unit maps the common control signal and the traffic data corresponding to each of the plurality of communication terminals to different subcarriers.

7. The apparatus of claim 1, further comprising:
an analog converting unit digital to analog converting the transmission signal corresponding to each communication terminal and outputting the analog signal; and
a frequency up converting unit up-converting a frequency of each transmission signal converted into the analog signal and outputting the frequency up converted signal through the antenna of the base station.

8. A method for processing a signal in a multiple access mobile communication system based on multiple beams, the method comprising:
modulating a common control signal and a traffic data signal to be transmitted to a plurality of respective communication terminals accessing a base station;
mapping the modulated common control signal and traffic data signal to subcarriers, respectively;
phase-shifting the common control signal mapped to the subcarrier as long as a delay time designated to correspond to the plurality of communication terminals, respectively; and
generating a transmission signal corresponding to each communication terminal by Fourier-transforming the subcarriers to which the common control signal and the traffic data signal phase-shifted as long as the designated delay time are mapped.

9. The method of claim 8, further comprising:
transmitting the transmission signal corresponding to each communication terminal through an antenna of the base station in the form of a beam,
wherein the common control signal corresponding to each communication terminal is each transmitted to the corresponding communication terminal through the beam with different delay time.

10. The method of claim 8, wherein the generating of the transmission signal corresponding to each communication terminal includes performing inverse fast Fourier transform (IFFT) of the subcarrier signal to which the common control signal and the traffic data signal phase-shifted as long as the designated delay time are mapped.

11. The method of claim 10, wherein the phase shifting includes calculating a phase shift value for the corresponding subcarrier in proportion to the number of time-domain samples of the delay time designated for the communication terminal which is to transmit the common control signal and in inverse proportion to the size of the IFFT of the Fourier transforming unit.

12. The method of claim 8, wherein in the modulating, the common control signal and the traffic data signal to be transmitted to each of the plurality of communication terminals are modulated by an Orthogonal Frequency Division Multiplexing (OFDM) scheme.

13. The method of claim 8, wherein in the mapping, the common control signal and the traffic data corresponding to each of the plurality of communication terminals are mapped to different subcarriers.

14. The method of claim 8, further comprising:
digital to analog converting the transmission signal corresponding to each communication terminal and outputting the analog signal; and
up-converting a frequency of each transmission signal converted into the analog signal and outputting the frequency up converted signal through the antenna of the base station.

15. A multiple access mobile communication system based on multiple beams, the system comprising:
a plurality of communication terminals supporting a communication service of a mobile communication system; and
a base station having a signal processing apparatus modulating a common control signal and a traffic data signal to be transmitted to a plurality of respective communication terminals and mapping the modulated signals to different subcarriers while multiple accessing the plurality of communication terminals, phase-shifting the common control signal mapped to the subcarrier as long as a delay time designated to correspond to the plurality of communication terminals, and transmitting each beam including the phase-shifted common control signal and traffic data signal to the corresponding communication terminal inside or outside.
